(19) United States
(12) Patent Application Publication
(10) Pub. No.: US 2007/0278713 A1
(43) Pub. Date: Dec. 6, 2007

(54) Method for producing a composite part by injection moulding, injection compression moulding or back compression moulding of a plastic material

(76) Inventors: Hans Suter, Eggenwil (CH); Manfred Kumper, St. Johann (DE)

Correspondence Address: WILLIAM COLLARD;COLLARD & ROE, P.C., 1077 NORTHERN BOULEVARD, ROSLYN, NY, 11576, US

(21) Appl. No.: 11/805,822

(22) Filed: May 24, 2007

Related U.S. Application Data
(62) Division of application No. 11/667,196, filed on May 24, 2007.

(30) Foreign Application Priority Data
Nov. 8, 2004 (EP) 04405684.4

(51) Int. Cl. B29C 45/16; B29C 70/30; B29C 70/34

(52) U.S. Cl. 264/255; 264/257; 264/258

(57) ABSTRACT

A method for producing a composite part from a first molded part and a second molded part via injection molding, injection compression molding or back compression molding of a plastic material, includes the following steps: producing the first molded part from a first plastic via such molding of the first plastic such that the first molded part features at least one elevation on one side, removing a segment of the first molded part and arranging the second molded part on the first molded part instead of the removed segment so that the respective elevation is situated on an edge of the second molded part, and applying a layer of a second plastic on the second molded part on the side facing away from the first molded part via injection molding, injection compression molding or back compression molding of the second plastic.

### CROSS REFERENCE TO RELATED APPLICATIONS

This application is a divisional of U.S. patent application Ser. No. 11/667,196, filed on May 24, 2007, which in turn is a national stage application of PCT/CH2005/000659 filed Nov. 8, 2005. The International Application under PCT article 21(2) was not published in English. This application also claims priority under 35 U.S.C. §119 of European Application No. 04405684.4 filed Nov. 8, 2004.

The invention pertains to a method for producing a composite part from a first moulded part and a second moulded part by means of injection moulding, injection compression moulding or back compression moulding of a plastic material.

Nowadays, numerous objects are produced from or by utilizing plastics because plastics provide various advantages. Plastics are organic materials of high molecular weight that exist in numerous variations and are predominantly produced synthetically, wherein a variety of chemical compounds with different material properties is available as source materials for a synthesis. Accordingly, plastic materials can be produced in large quantities and with a broad variety of material properties (mechanical, chemical, electrical properties, etc.), for example, in the form of thermoplastic polymers, thermosetting polymers, foamed plastics, elastomers, electrically conductive plastics, materials with embedded plastics as a mechanical reinforcement (for example, fiber-reinforced materials), etc.

Unshaped source products of plastic (polymer melts) can be processed into shaped products (moulded parts, semi-finished products) in a relatively cost-efficient fashion with a series of standard processes, for example, by means of injection moulding or injection compression moulding plastic materials with the aid of suitably shaped moulding tools or by means of back compression moulding of plastic materials (in this context, this refers to “pressing a plastic material on the back of a given material structure”) with a suitably shaped moulding tool.

Such techniques make it possible to precisely and cost-efficiently produce large quantities of plastic products with nearly arbitrary shapes and with reproducible material properties.

A suitable choice of the plastics to be processed makes it possible to optimize the material properties of the respective moulded parts for specific applications.

Moulded parts frequently should fulfill several different optimization criteria simultaneously, for example, with respect to the mechanical strength and the elastic properties, the electric conductivity, the optical properties, the quality of the surface with respect to friction or an optical impression, the resistance to certain chemicals, the thermal properties, etc. However, it is usually impossible to simultaneously fulfill several such varied requirements with a single material.

In order to create moulded parts that fulfill various technical requirements, the experts aim to combine different materials with one another (for example, different plastics or a plastic and other materials) and to process these materials into a moulded part in combined form.

For example, WO 99/47328 discloses different processes and corresponding devices for the back injection moulding or back compression moulding of a plastic on the back of decorative materials (for example, carpets, textiles, foils): according to this method, a flat structure of a decorative material and a plastic are processed into a moulded part by respectively injecting and moulding (in a mould cavity with stationary mould cavity walls) or compressing and moulding (in a mould cavity with movable mould cavity walls in order to compress the plastic) a fictile (non-hardened) plastic mass on one side of the respective structure. During this process, the decorative material and the plastic are bonded to one another on a common boundary surface during the hardening of the plastic and thusly form a moulded part, the shape of which is defined by the shape of the respective mould cavity. One portion of the surface of such a moulded part is formed by one side of the decorative material while the plastic portion of the moulded part serves as a substrate for the decorative material and ensures the required mechanical stability.

In order to create complex structures of plastic or by utilizing plastic, it can be attempted to connect different moulded parts into a composite part with the aid of a plastic or plastics, respectively, wherein the composite part should also have a predetermined shape, if so required. However, the realization of such a composite part to be produced from different moulded parts may be problematic. For example, certain regions of the surface of at least one of the respective moulded parts could feature a material incapable of producing a chemical and/or physical bond that can be subjected to mechanical loads during the injection moulding or injection compression moulding or back compression moulding of a plastic. This limits the options for connecting one moulded part and another moulded part into a composite part by means of injection moulding or injection compression moulding or back compression moulding of plastic materials.

The invention aims to solve this problem. The invention is based on the objective of developing a process and a system for producing a composite part from a first moulded part and a second moulded part by means of injection moulding or injection compression moulding or back compression moulding of a plastic material in which the material or the materials of one of the moulded parts can be largely chosen independently of the material or the materials of the other moulded part. It should also be possible, in particular, to bond the two moulded parts to one another by means of the plastic if this plastic does not produce a bond that can be subjected to a load with one of the moulded parts on a boundary surface with this moulded part.

This objective is attained with a process with the characteristics of claim 1.

According to the invention, the following steps (a) to (c) are carried out in order to produce a composite part from a first moulded part and a second moulded part by means of injection moulding or injection compression moulding or back compression moulding of a plastic:

(a) producing the first moulded part from a first plastic by means of injection moulding or injection compression moulding or back compression moulding of the first plastic such that the first moulded part features at least one elevation on one side,

(b) removing a segment of the first moulded part by punching out, cutting out or otherwise removing the segment and arranging the second moulded part on the first moulded part instead of the removed segment of the first moulded part in such a way that the respective elevation is situated on an edge of the second moulded part, and

(c) applying a layer of a second plastic on the second moulded part on the side facing away from the first moulded part by means of injection moulding or injection compression moulding or back compression moulding of the second plastic, namely in such a way that both one surface of the elevation and the second moulded part are at least partially covered by the layer and the first plastic and the second plastic form a bond that holds the two moulded parts together in the region of the elevation.

Moulding tools suitable for the injection moulding or the injection compression moulding or the back compression moulding of plastics can be used for producing the first moulded part in accordance with step (a) and for applying the layer in accordance with a step (c). Consequently, such moulding tools may be constructed in accordance with known principles. In step (b), it is ensured that both moulded parts are suitably positioned relative to one another such that step (c) can be carried out. Step (b) can be carried out manually or automatically.

It is essential for the invention that the first moulded part is moulded during the injection moulding or the injection compression moulding or the back compression moulding of the first plastic such that it features at least one elevation on one side, i.e., a region of the surface that outwardly protrudes over adjacent regions of the surface. The first moulded part and the second moulded part are connected into a composite part in that the layer consisting of the second plastic is bonded to the elevation and at least partially covers the second moulded part on the side facing away from the first moulded part in accordance with step (c). The bond between the layer and the elevation on the surface of the first moulded part results in the second moulded part being at least mechanically held between the layer and the first moulded part due to the bond with the elevation. This ensures that the first moulded part and the second moulded part are also held together if the second plastic does not firmly adhere to the surface of the second moulded part or the second plastic is not chemically or physically bonded at the surface of the second moulded part.

In order to ensure that the elevation is accessible to the second plastic when the layer is applied during the injection moulding or the injection compression moulding or the back compression moulding in accordance with step (c), the second moulded part should be arranged on the first moulded part such that the respective elevation is situated on an edge of the second moulded part in accordance with step (b). Such an edge may consist, for example, of the edge of a hole extending through the second moulded part. However, the edge may also be realized on the periphery of the second moulded part, for example, on a recess or indentation in the surface of the second moulded part.

It is therefore possible to hold together the first moulded part and the second moulded part regardless of the choice of material used for the second moulded part. This is the reason why the invention makes it possible to largely choose the material of the second moulded part independently of the material of the first moulded part and the second plastic, respectively.

The bond between the first moulded part and the second moulded part can be realized in different ways.

For example, the second plastic may be chosen such that the connection between the first moulded part and the second moulded part is realized due to chemical bonds between the first plastic and the second plastic. The first plastic and the second plastic, for example, may be identical or have similar melting points if the two plastics are not identical. In these instances, the layer can be applied at a temperature at which the first plastic is softened or liquefied in at least a section of the elevation. The first plastic and the second plastic can mix on a boundary surface between the elevation and the layer under these prerequisites and be connected to one another by means of chemical and/or physical bonds. This type of connection is particularly stable and can be realized quite easily with respect to the process technology.

In another variation of the inventive process, the respective elevation can be realized in such a way in step (a) that it features at least one undercut and the layer is bonded to the elevation in the region of the undercut. In this case, the layer and the second moulded part are bonded to the elevation and therefore to the first moulded part by means of a mechanical connection in any case. This variation provides the advantage that the first moulded part and the second moulded part can also be connected into a composite part if the second plastic does not adhere to the first moulded part or if the second plastic cannot be chemically and/or physically bonded to the material of the first moulded part.

For example, this variation can also be utilized if the first plastic and the second plastic differ significantly with respect to their melting points (for example, if the first plastic has a much higher melting point than the second plastic such that the first plastic does not become soft or slightly melts when the layer consisting of the second plastic is applied).

The elevation of the first moulded part and the edge that is realized on the second moulded part and, according to step (b), positioned on the respective elevation can be optimized in accordance with different criteria and functionally adapted to one another, if so required.

The size of the surface of the elevation can be suitably varied in order to optimize the strength (i.e., the stability under mechanical loads) of the bond between the elevation and the layer consisting of the second plastic. The strength of this bond usually increases with the size of the boundary surface, at which the second plastic is in contact with the respective elevation. In this case, the second plastic does not have to completely cover the respective elevation. The elevation can also penetrate the layer consisting of the second plastic in such a way that the respective elevation is only in contact with the layer in the region of lateral surfaces and an upper part of the elevation respectively protrudes over the layer.

If the elevation needs to have a small cross-sectional surface for space reasons, the strength of the bond between the elevation and the layer can be optimized by choosing the height of the elevation and the thickness of the layer accordingly. According to one variation of the inventive process, it is therefore proposed that the respective elevation has such dimensions that it protrudes over the second moulded part on the respective edge. The height of the elevation is chosen such that the bond between the layer applied in step (c) and the respective elevation reaches a predetermined strength.

The shape of the respective elevation is not subject to any general restrictions and may be suitably chosen in dependence on the respective application. An elevation may have a round or angular cross-sectional surface and be realized, for example, in the form of a pin or a column or a cylinder or a cone or a rib.

According to another variation of the inventive process, the second moulded part features at least one hole or one recess and the hole or the recess forms the respective edge, wherein the second moulded part is arranged in such a way that the elevation protrudes into the hole or the recess or penetrates the hole or the recess. This variation provides the advantage that the respective elevation can be used for easily adjusting the second moulded part relative to the first moulded part while step (b) is carried out, i.e., before step (c): each elevation on the surface of the first moulded part merely needs to be positioned opposite of the corresponding hole or the corresponding recess in the second moulded part. This variation provides a particular advantage if the first moulded part features several elevations and the second moulded part features several corresponding holes or recesses, respectively: in this case, the second moulded part is already arranged relative to the first moulded part as required in step (b) due to the positions of the elevations and the positions of the corresponding holes or recesses.

The above-described variations provide other advantages in applications in which the second moulded part consists of a structure of a flexible material, for example, of textiles and/or a woven fabric and/or a braiding and/or a foil and/or a carpet fabric and/or decorative material. The elevations realized on the first moulded part and the holes or recesses produced in the second moulded part make it possible to adjust the flexible structure with respect to the elevations in step (b) and, if so required, to hold the flexible structure on the elevations in such a way that it is clamped between the elevations. In this case, the back injection moulding or back compression moulding of the second plastic in accordance with step (c) makes it possible to produce a composite part in which a section of the surface is lined with the flexible structure. The above-described method of adjusting the flexible structure on the elevations and clamping the flexible structure between the elevations provides significant advantages in the production of such composite parts: the quality of the surfaces is improved; the composite parts can be produced with greater accuracy and improved reproducibility.

Embodiments of the invention are described below with reference to various schematic drawings. In these drawings:

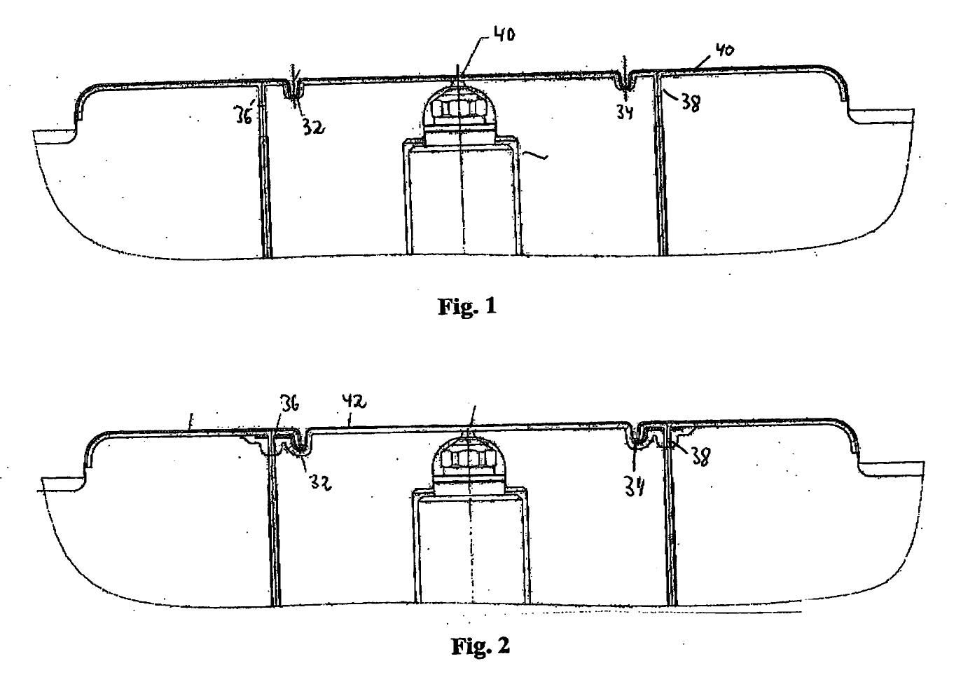

FIG. 1 shows a cross section through a first moulding tool for producing a first moulded part from a first plastic that is introduced into a mould cavity of the moulding tool;

FIG. 2 shows a section through the moulding tool according to FIG. 1 and a first moulded part arranged in the mould cavity thereof along the line II-II in FIG. 1;

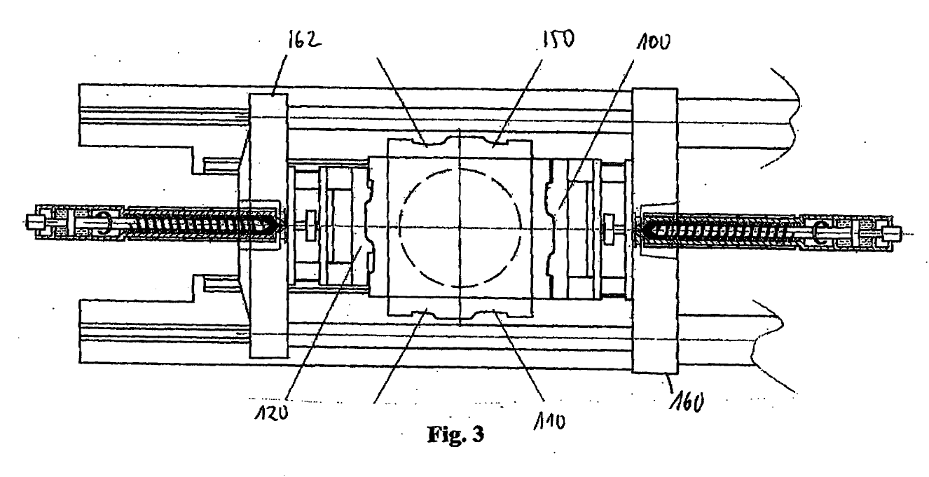

FIG. 3 shows a cross section through a second moulding tool with a mould cavity for accommodating a first moulded part that is produced with the first moulding tool according to FIG. 1, as well as for accommodating a second moulded part and for producing a composite part from the first moulded part and the second moulded part by filling the mould cavity with a second plastic;

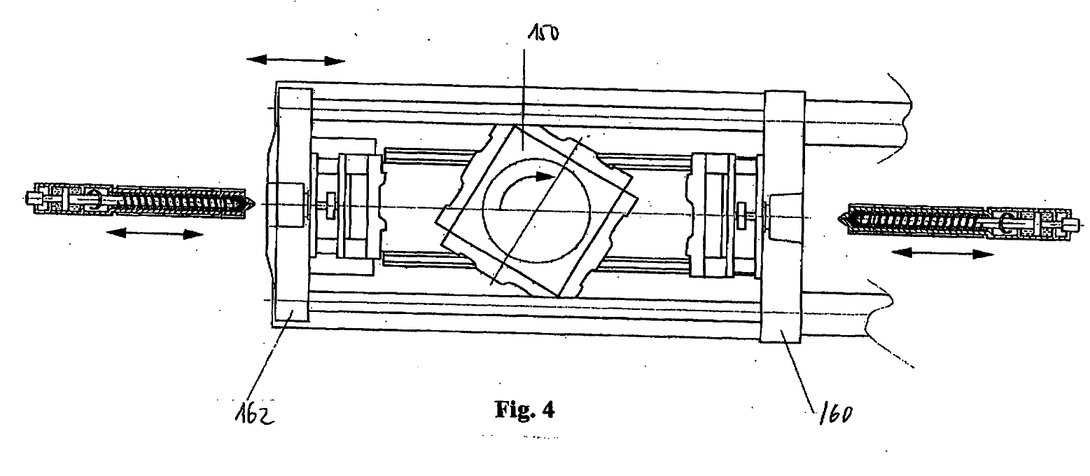

FIG. 4 shows a top view of part of the second moulding tool according to FIG. 3 with an arrangement of the first moulded part and the second moulded part, namely in the direction IV-IV indicated in FIG. 3;

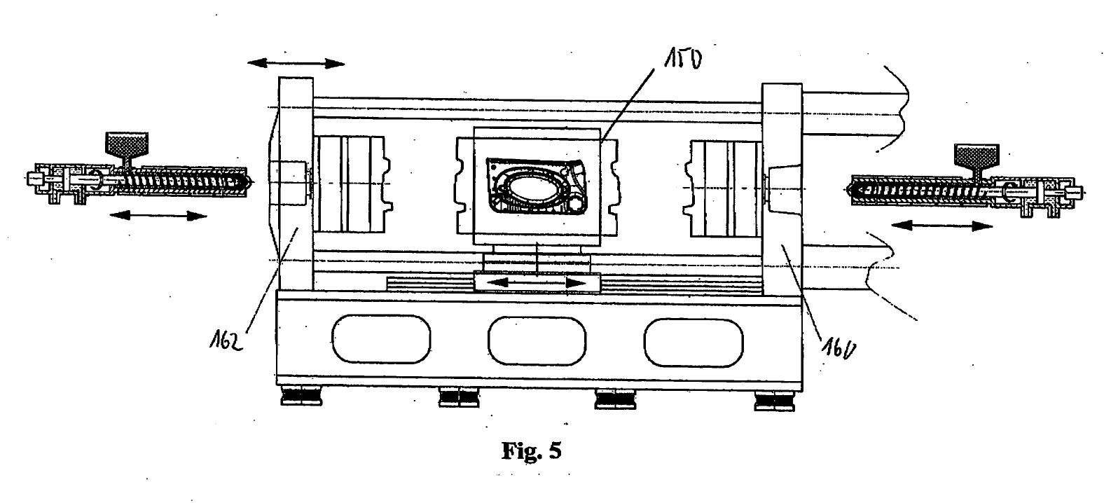

FIG. 5 shows a composite part produced with the second moulding tool according to FIG. 3;

FIG. 6 shows a cross section through a first moulding tool for producing a first moulded part by means of back injection moulding or back compression moulding of a first plastic on the back of a structure of a flexible material in a mould cavity of the moulding tool;

FIG. 7 shows a section through part of a first moulded part produced with the first moulding tool according to FIG. 6 along the line VII-VII in FIG. 6;

FIG. 8 shows a cross section through a second moulding tool with a mould cavity for accommodating a first moulded part that is produced with the first moulding tool according to FIG. 6, as well as for accommodating a second moulded part in the form of a structure of flexible material and for producing a composite part from the first moulded part and the second moulded part by filling the mould cavity with a second plastic;

FIG. 9 shows a section through an arrangement of the first moulded part and the second moulded part according to FIG. 8 along the line IX-IX in FIG. 8, and

FIG. 10 shows a cross-section through a composite part produced with the second moulding tool according to FIG. 8.

FIGS. 1-5 show the production of a composite part 30 from a first moulded part 10 and a second moulded part 15 according to one variation of the invention.

In a first step, the first moulded part 16 is produced from a first plastic 8 by means of a moulding tool 1 (FIG. 1). The moulding tool 1 is divided into a first part 2 and a second part 3 that can be moved relative to one another in order to open and close the moulding tool 1. FIG. 1 shows the moulding tool 1 in the closed state. In this state, the first part 2 and the second part 3 form the walls of a mould cavity 5, the shape of which corresponds to the outside contour of the moulded part 10 to be produced.

In this variation, the moulding tool 1 is used as an injection moulding tool. The first plastic 8 supplied through a supply line 7 is injected under high pressure into the mould cavity 5 of the closed moulding tool via a channel 6—in plasticized form (injection moulding polymer melt)—until the mould cavity 5 is completely filled. The first plastic 8 transforms into the solid state in the mould cavity 5 due to a suitable control of the operating conditions. Subsequently, the moulding tool 1 can be opened and the finished moulded part 10 can be removed.

According to FIGS. 1 and 2, the second part 3 of the moulding tool 1 features several depressions 11 that are respectively shaped like a cylinder on the side of the mould cavity. Accordingly, one side of the moulded part 10 features cylindrical elevations 11′ that represent castings of the depressions 11 and are shaped correspondingly.

According to FIG. 2, the first moulded part 10 of the discussed example is realized flat and has the shape of a C. In addition, the elevations 11′ are arranged along one edge of the first moulded part. It should be noted that the invention can also be used in connection with moulded parts of different shapes.

FIG. 3 shows a moulding tool 12 that is divided into a first part 13 and a second part 14. The parts 13 and 14 can be moved relative to one another in order to open and close the moulding tool 12. FIG. 3 shows the moulding tool 12 in the closed state. In this state, the first part 13 and the second part 14 form the walls of a mould cavity.

The moulding tool 12 is used for connecting the moulded parts 10 and 15 into a composite part 30 with the aid of a second plastic 21. In this example, the moulding tool 12 is used as an injection moulding tool. The second plastic 21 may (but does not have to) be identical to the first plastic 8.

According to FIGS. 3-5, the moulded parts 10 and 15 of the discussed example are shaped such that they completely cover a continuous surface—when they are placed adjacent to one another in a mosaic-like fashion. In FIG. 4, the moulded part 15 features a series of through-holes 16. The geometric arrangement of the holes 16 corresponds to the arrangement of the elevations 11′ on the surface of the first moulded part 10.

FIGS. 3 and 4 show that the first moulded part 10 and the second moulded part 15 can be inserted between the walls of the mould cavity 20 formed by the first part 13 in a precisely fitted fashion and thusly adjusted relative to the mould cavity. The second moulded part 15 is arranged relative to the first moulded part 10 in such a way that the elevations 11′ protrude into the corresponding holes 16 in the second moulded part 15. According to the definition of the invention, the second moulded part 15 is arranged on the first moulded part 10 in such a way that the respective elevation 11′ is situated on an edge of the second moulded part 15.

According to FIG. 3, each elevation 11′ has such dimensions that it protrudes over the edge of the respective hole 16 of the second moulded part 15. The mould cavity 20 is not completely filled out by the first moulded part 10 and the second moulded part 15. Clear recesses are provided on the side of the second moulded part 15 that faces away from the first moulded part 10, namely in the vicinity of the elevations 11′ and the holes 16.

The second plastic 21 supplied through a supply line 7 is injected under high pressure into these clear recesses of the mould cavity 20 via a channel 6—in plasticized form (injection moulding polymer melt)—until the recesses are completely filled. A suitable control of the operating conditions ensures that the second plastic 21 transforms into the solid state in the mould cavity 20 and forms a layer 20′ that covers part of the second moulded part 15 and the elevations 11′.

In this context, it is assumed that the second plastic 21 is connected to the first plastic 8 by means of chemical and/or physical bonds in the region of the elevations 11′. The first moulded part 10 and the second moulded part 15 are connected into the composite part 30 in this fashion. Subsequently, the moulding tool 12 can be opened and the finished composite part 30 can be removed.

The composite part 30 produced in accordance with the inventive process is illustrated in FIG. 5. In this example, the layer 20′ forms mushroom-like covers 26 over the elevations 11′.

FIGS. 6-10 show the production of a composite part 90 from a first moulded part 60 and a second moulded part 80 according to another variation of the invention. In this example, the moulded part 60 as well as the moulded part 80 respectively features a structure of a flexible material, for example, of textiles and/or a woven fabric and/or a braiding and/or a foil and/or a carpet fabric and/or a decorative material.

In a first step, the first moulded part 60 is produced from a structure 50 of a flexible material and a first plastic 8 by means of a moulding tool 40 (FIG. 6). The moulding tool 40 is divided into a first part 41 and a second part 42 that can be moved relative to one another in order to open and close the moulding tool 40. FIG. 6 shows the moulding tool 40 in the closed state. In this case, the first part 41 and the second part 42 form the walls of a mould cavity 45, the shape of which corresponds to the outside contour of the moulded part 60 to be produced.

Before the moulding tool 40 is closed, the structure 50 is placed against the wall of the first part 41 on the side of the mould cavity. According to FIG. 6, the structure 50 fills out part of the mould cavity 45 and is arranged in such a way that it follows the contour of the wall of the first part 41 on the side of the mould cavity.

In the example shown, the moulding tool 40 is used as an injection moulding tool. The first plastic 8 supplied through a supply line 49 is injected under high pressure behind the structure 50 in the mould cavity 45 of the closed moulding tool 40—in plasticized form (injection moulding polymer melt)—until the mould cavity 45 is completely filled. A suitable control of the operating conditions ensures that the first plastic 8 transforms into the solid state in the mould cavity 45 and forms a layer 45′ that is bonded to the structure 50. Subsequently, the moulding tool 40 can be opened and the finished moulded part 60 can be removed.

In this case, the structure 50 forms a surface of the first moulded part 60 while the layer 45′ serves as a substrate for the structure 50 and provides the moulded part 60 with the required mechanical stability.

According to FIGS. 6 and 7, the first part 41 of the moulding tool 40 features two elevations 46 on the surface of the first part 41 of the moulding tool 40 that lies on the side of the mould cavity. Consequently, contours 46′ that are defined by elevations 46 are realized on the surface of the first moulded part 60.

FIGS. 6 and 7 also show that the second part 42 of the moulding tool 40 features several depressions 47 on the side of the mould cavity, each depression having the shape of a cylinder. Accordingly, one side of the moulded part 60 features cylindrical elevations 47′ that represent castings of the depressions 47 and are shaped correspondingly.

A composite part 90 featuring a structure of a flexible material that differs from the structure 50 in a region of its surface should be produced of the moulded part 60 in additional processing steps. FIGS. 7-10 schematically show a solution for attaining the objective that forms the basis of the invention.

As indicated in the FIGS. 7 and 8, a segment 60.1 of the first moulded part 60 that extends between the contours 46′ is initially punched out, cut out or removed otherwise, wherein said segment has a width that corresponds to the spacing between the contours 46′ and a length that corresponds to part of the length of the moulded part 60 in the longitudinal direction of the contours 46′.

According to the invention, the second moulded part 80 can now be arranged on the thusly modified first moulded part 60 instead of the removed segment 60.1 and connected to the moulded part 60 by back injection moulding or back compression moulding of a second plastic.

The moulding tool 70 according to FIG. 8 is provided for this purpose.

The moulding tool 70 is divided into a first part 71 and a second part 72. The parts 71 and 72 can be moved relative to one another in order to open and close the moulding tool 70. FIG. 8 shows the moulding tool 70 in the closed state. In this case, the first part 71 and the second part 72 form the walls of a mould cavity 75.

After removing the segment 60.1, the first moulded part 60 is placed into the mould cavity 75 in such a way that the structure 50 adjoins the wall of the first part 71 on the side of the mould cavity and is supported by elevations 86 in edge regions. The layer 45′ and the elevations 47′ are accessible from the mould cavity 75 under these conditions.

A structure of a flexible material is used as the moulded part 80. According to FIGS. 8 and 9, the moulded part 80 features a series of through-holes 81, wherein the geometric arrangement of the holes 81 corresponds to the arrangement of the elevations 47′ on the surface of the first moulded part 60.

The second moulded part 80 is arranged relative to the first moulded part 60 in such a way that the elevations 47′ protrude into corresponding holes 81 in the second moulded part 80. According to the definition of the invention, the second moulded part 80 therefore is arranged on the first moulded part 60 in this position such that the respective elevation 47′ is situated on an edge of the second moulded part 80.

According to FIG. 8, each elevation 47′ has such dimensions that it protrudes over the edge of the second moulded part 80 formed by the respective holes 81. The mould cavity 75 is not completely filled out by the first moulded part 60 and the second moulded part 80. Clear recesses are provided on the side of the second moulded part 80 that faces away from the first moulded part 60, namely in the vicinity of the elevations 47′ and the holes 81.

The second plastic 21 supplied through a supply line 49 is injected under high pressure into the clear recesses of the mould cavity 75 via a channel 76—in plasticized form (injection moulding polymer melt)—until the recesses are completely filled. A suitable control of the operating conditions ensures that the second plastic 21 transforms into the solid-state in the mould cavity 75 and forms a layer 75′ that covers one side of the second moulded part 80 and the elevations 47′.

In this context, it is assumed that the second plastic 21 is connected to the first plastic 8 by means of chemical and/or physical bonds in the region of the elevations 47′. The first moulded part 60 and the second moulded part 80 are connected into the composite part 90 in this fashion. Subsequently, the moulding tool 70 can be opened and the finished composite part 90 can be removed.

The composite part 90 produced in accordance with the inventive process is illustrated in FIG. 10. The reference symbol 86′ identifies a contour that is defined by one of the elevations 86.

The embodiments illustrated in FIGS. 1-8 were only described with respect to the special instance in which the first plastic and the second plastic are processed by means of injection moulding or back injection moulding. However, this does not mean that the invention can only be carried out based on these techniques. On the contrary, the discussed procedures can be transferred analogously to other techniques such as injection compression moulding or back compression moulding.

The invention makes it possible to embed a variety of materials in composite parts by means of injection moulding or injection compression moulding or back compression moulding of a plastic material, e.g., metal and/or wood and/or other materials that cannot be connected to plastics by means of chemical and/or physical bonds.

All materials suitable for injection moulding or injection compression moulding or back compression moulding may be considered for use as plastics, for example, thermoplastic polymers such as polycarbonate (PC), ABS (acrylonitrile-butadiene-styrene polymers) or polypropylene or thermoplastic rubbers, as well as thermosetting bulk moulding compounds such as, e.g., polyester resins, epoxy resins or polyurethane.

1. A method for producing a composite part from a first moulded part and a second moulded part by means of injection moulding, injection compression moulding or back compression moulding of a plastic material, comprising the following steps:
(a) producing the first moulded part from a first plastic by means of injection moulding or injection compression moulding or back compression moulding of the first plastic such that the first moulded part features at least one elevation on one side,
(b) removing a segment of the first moulded part by punching out, cutting out or otherwise removing the segment and arranging the second moulded part (15, 80) on the first moulded part instead of the removed segment in such a way that the respective elevation is situated on an edge of the second moulded part, and
(c) applying a layer of a second plastic (21) on the second moulded part on the side facing away from the first moulded part by means of injection moulding or injection compression moulding or back compression moulding of the second plastic, namely in such a way that both one surface of the elevation and the second moulded part are at least partially covered by the layer and the first plastic and the second plastic form a bond in the region of the elevation, the bond holding the two moulded parts together.

2. The method according to claim 1, wherein the layer is applied at a temperature at which the first plastic is softened or liquefied in at least a section of the elevation.

3. The method according to claim 1, wherein the elevation features at least one undercut and the layer is bonded to the elevation in the region of the undercut.

4. The method according to claim 1, wherein the respective elevation has such dimensions that it protrudes over the second moulded part on the respective edge.

5. The method according to claim 1, wherein the elevation is realized in the form of a pin or a column or a cylinder or a cone or a rib.

6. The method according to claim 1, wherein the second moulded part features at least one hole or one recess and the hole or the recess forms the respective edge, and wherein the second moulded part is arranged in such a way that the elevation protrudes into the hole or the recess or penetrates the hole or the recess.

7. The method according to claim 1, wherein the first moulded part is produced by injecting or pressing a first plastic on the back of a first structure of a flexible material such that the structure is bonded to the first plastic and forms a surface of the first moulded part.

8. The method according to claim 7, wherein the respective elevation is realized on the side of the first moulded part that faces away from the first structure.

9. The method according to claim 7, wherein the first structure consists of textiles and/or a woven fabric and/or a braiding and/or a foil and/or a carpet fabric and/or a decorative material.

10. The method according to claim 1, wherein the second moulded part is a second structure of a flexible material.

11. The method according to claim 10, wherein the second structure consists of textiles and/or a woven fabric and/or a braiding and/or a foil and/or a carpet fabric and/or a decorative material.

12. The method according to claim 1, wherein the second moulded part is made of metal and/or plastic and/or wood.

13. The method according to claim 1, wherein the first moulded part and the second moulded part form adjacent regions of a surface of the composite part.
